(19) United States
(12) Patent Application Publication
(10) Pub. No.: US 2009/0305054 A1
(43) Pub. Date: Dec. 10, 2009

(54) Means for applying and wiping away a liquid

(75) Inventor: Wolf-Rüdiger Huck, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/309,318

(22) PCT Filed: Jul. 26, 2007
(86) PCT No.: PCT/EP2007/057732

§ 371 Date: Jan. 26, 2009

(30) Foreign Application Priority Data
Jul. 26, 2006 (EP) 06117918.0

(51) Int. Cl. B32B 17/06; B32B 37/02; B32B 19/00; B32B 15/04; B32B 21/04

(52) U.S. Cl. 428/426; 156/390; 156/60; 428/688; 428/457; 428/537.1

(57) ABSTRACT

A means for applying and wiping away a liquid, having a container with a filling space and at least one opening for the application of the liquid, characterized in that, on the outside of the container, which side does not have at least one opening, the means has at least one porous support material for wiping away the liquid.

### FIELD OF THE INVENTION

The invention relates to the field of the application technology for applying and wiping off a liquid on a surface. More particularly the invention relates to a means for applying and wiping off a liquid, comprising a container having a filling chamber and at least one aperture for applying the liquid, characterized in that the container, on the outer side, has at least one porous carrier material for wiping off the liquid.

### BACKGROUND ART

Hydrolyzable liquids such as adhesion promoter compositions have long been used for improving adhesion, more particularly that of adhesives and sealants. In particular, silane compounds and titanate compounds have long been known as such adhesion promoter compositions. These adhesion promoter compositions are used as primers or adhesion activators for the pretreatment of surfaces where adhesive bonding or sealing is to take place.

The application of these liquids to a surface is accomplished for example by a spraying, spreading or rolling process. All of the known processes, however, suffer from the problem that the metering of the applied amount is difficult. Thus, when carrying out application by means of brush, cloth, felt or sponge, it is necessary in some cases to wipe off part of the applied amount again in a second step, using a further cloth, felt or sponge. Accordingly, in addition to the liquid and to the apparatus for applying the liquid, a cleaning cloth, felt or sponge is needed; this is expensive and necessitates a greater time for application, since there are two different items which must be used in order to apply the liquid and to wipe it off again afterward.

There is therefore a need to allow a liquid to be applied and wiped off with an application apparatus without the need to use another, auxiliary means for wiping off after application.

### BRIEF DESCRIPTION OF THE INVENTION

It is an object of the present invention, therefore, to provide a means which overcomes the disadvantages of the prior art and more particularly makes it possible for liquids to be applied to a predefined region of a surface and then wiped off again.

Surprisingly it has been found that the means according to claim 1 achieves this object.

Said means for applying and wiping off a liquid is suitable more particularly for adhesion promoter compositions which are used for improving the adhesion for adhesives and sealants.

The use of a means of the invention permits a rapid and reliable application method for a liquid, more particularly an adhesion promoter composition, leading to more rapid and more reliable operation when bonding and sealing, and also to lower costs of material or of labor.

The present invention accordingly further provides a method of bonding and sealing, a bonded or sealed article, and a built structure or means of transport.

Preferred embodiments of the invention are subject matter of the dependent claims.

### BRIEF DESCRIPTION OF THE DRAWING

Exemplary embodiments of the invention are elucidated in greater detail below with reference to the drawings. Like elements in the various figures are given the same reference symbols.

The figures show:

FIG. 1A diagrammatic representation of a longitudinal section through a container,

FIG. 1B diagrammatic representation of a cross section through a container from FIG. 1A along the line A-A in a first embodiment,

FIG. 1C diagrammatic representation of a cross section through a container from FIG. 1A along the line A-A in a second embodiment,

FIG. 1D diagrammatic representation of a cross section through a container from FIG. 1A along the line A-A in a third embodiment,

FIG. 2A diagrammatic representation of a longitudinal section through a means of the invention,

FIG. 2B diagrammatic representation of a cross section through the side bearing at least one aperture of the container from FIG. 2A, along the line B-B,

FIG. 2C diagrammatic representation of a cross section through the side bearing at least one aperture of the container from FIG. 2A, along the line B-B,

FIG. 3A diagrammatic representation of a longitudinal section through a means of the invention in a second embodiment,

FIG. 3B diagrammatic representation of a cross section through a container from FIG. 3A along the line C-C,

FIG. 4A diagrammatic representation of a longitudinal section through a means of the invention in a third embodiment,

FIG. 4B diagrammatic representation of a cross section through the side bearing at least one aperture of the container from FIG. 4A, along the line D-D,

FIG. 5A diagrammatic representation of a longitudinal section through a means of the invention in a fourth embodiment,

FIG. 5B diagrammatic representation of a longitudinal section through a means of the invention in a fifth embodiment,

FIG. 5C diagrammatic representation of a longitudinal section through a means of the invention in a sixth embodiment,

FIG. 5D diagrammatic representation of a cross section through the container from FIG. 5C along the line E-E,

FIG. 5E diagrammatic representation of a longitudinal section through a means of the invention in a seventh embodiment,

FIG. 6A diagrammatic representation of a longitudinal section through a means of the invention in an eighth embodiment,

FIG. 6B diagrammatic representation of a longitudinal section through a means of the invention in a ninth embodiment.

Only the elements essential to the immediate understanding of the invention have been shown.

### EMBODIMENT OF THE INVENTION

The present invention relates to a means for applying and wiping off at least one liquid on a substrate surface, comprising a container having a filling chamber and at least one aperture for applying the liquid, characterized in that the means, on the outer side of the container that does not have the at least one aperture, has at least one porous carrier material for wiping off the liquid.

The container may be for example a tube or a pot. The container comprises at least one aperture for applying the liquid. The at least one aperture is disposed on one side of the container, preferably on the lid or at the tube head. Where the container is a pot, the pot lid preferably comprises at least one and preferably two or more apertures, preferably a plurality of small holes.

The container is made of a stable or readily deformable, preferably thin-walled material. The material is preferably a plastic, cardboard or a metal, aluminum for example, or a composite material, such as an aluminum-coated plastic, for example. Suitable plastic is more particularly polyolefin, preferably polypropylene or polyethylene or mixtures thereof. The container may be produced from a single material throughout, or may be composed of different materials. The container preferably comprises a base, a lid, and at least one wall, preferably a jacket. The base, the lid and the at least one wall may be composed of the same material or of different materials and may be produced individually or in a single piece, by casting, for example. The lid in particular may be made from a different material than the rest of the container, as for example of a film which can be punctured.

The container is preferably circular, oval or angular, such as triangular, tetrangular, pentangular or multiangular, for example, and preferably of hollow-cylindrical shape. The container may include indentations, bulges or other deformations or may form a highly ergonomic shape, so that the user can hold the container effectively, and so that application and wiping off are simplified. The container may further comprise mounting elements, such as clips or screws, for example, or others. Mounting elements of this kind are preferred more particularly when the container is used mechanically, and the container will affix to a machine. Located within the container is a filling chamber which can be filled with liquid. The container, which has at least one aperture, can be closed so that the liquid does not emerge unhindered. This is especially preferred when the liquid is located directly in the filling chamber of the container, without being additionally closed in a minicontainer.

The at least one porous carrier material for wiping off the liquid is disposed on that outer side of the container that does not include an aperture. Preferably the porous carrier material is disposed on the outer side of the container that is opposite the aperture, preferably on the base of the container. The porous carrier material may also be disposed on more than one outer side of the container; for example, on the base and on an outer wall of the container, or only on an outer wall.

By “porous” throughout the present text is meant a material which has interstices, especially cavities, which are able to accommodate a liquid or which are pervious to a liquid. A fiber material, such as a nonwoven web, a felt or a brush, for example, is also considered porous in the sense of the present invention.

The porous carrier material for wiping off the liquid comprises or is preferably a fiber material or a sponge.

By fiber material is meant throughout the present document a material which is constructed of fibers. The fibers comprise or consist of organic or synthetic material. More particularly they are cellulosic fibers, cotton fibers, protein fibers or synthetic fibers. Particularly preferred synthetic fibers include fibers of polyester or of a homopolymer or copolymer of ethylene and/or propylene, or of viscose. These fibers may be short fibers or long fibers, spun, woven or non-woven fibers or filaments. Additionally the fibers may be oriented or drawn fibers. Additionally it may be advantageous to use different fibers, both in geometry and composition, with one another.

The fiber material further comprises cavities. These cavities are constructed by means of suitable production processes. In this context it is preferred for the cavities not to be completely closed off, but instead to communicate with the surroundings directly or via channels. In this way the intention is that a spongelike structure is created which allows in particular a high accommodation capacity for liquids.

The element constructed of fibers may be produced in any of a very wide variety of processes known to the person skilled in the art. Elements employed are more particularly those which are a woven, laid or knitted fabric.

The fiber material may be a relatively loose material of spun fibers or filaments, whose cohesion is provided in general by the adhesion of the fibers themselves. In this context the individual fibers may have a preferential direction or may be undirected. The element constructed of fibers may be mechanically consolidated by needling, intermeshing or by entangling by means of sharp water jets.

A particularly preferred fiber material is a microfiber cloth, felt or nonwoven web. Wool or brushes, however, can also be used.

By a sponge is meant throughout the present document a material which is composed of foamed elastic material. Both organic and synthetic materials are suitable, more particularly a natural sponge or a plastic produced using blowing agents. The sponge comprises cavities or pores, which are constructed by means of suitable production processes or which are present in the natural sponge. In this context it is preferred for the cavities not to be completely closed off, but instead to communicate with the surroundings directly or via channels. In this way the intention is that a spongelike structure is created which allows in particular a high accommodation capacity for liquids.

The foamed plastic is composed preferably of polymers which comprise or consist of natural or synthetic elastic polymers, rubber formed from vulcanized rubber, or thermoplastics. A plastic suitable as a sponge is elastic at service temperature, in other words at temperatures between −20 to 50° C., preferably between 0 to 40° C., more preferably between 10 to 30° C., in particular at 20° C.

Examples of suitable polymers are curing products of polymers which contain isocyanate groups, acrylate groups, epoxy groups and/or silane groups, or mixture thereof. Particular suitability is possessed by polymers based on polyurethanes. Likewise suitable are melamine foams.

The fiber material, more particularly a cloth, felt or nonwoven web, or the sponge, may additionally be coated, and in particular flocked, preferably with fibers of organic or synthetic material. For example, the fiber material or the sponge may first be coated with an adhesive and then flocked with fibers, so that the fibers, natural hair for example, adhere to the adhesive and form a carpetlike or brushlike layer. The adhesive selected must be a porous adhesive which is pervious for a liquid. Coated fiber materials or sponges of this kind are especially suitable for the application means used for applying the liquid to at least one substrate surface.

The outer side of the container that bears at least one aperture preferably has an application means which simplifies the application of the liquid to a substrate surface.

The application means for applying the liquid is preferably a sponge or a fiber material. A suitable sponge or fiber material is one as described above for the porous carrier material.

The application means and the porous carrier material, in the context of the means of the invention for applying and wiping off a liquid, may be composed of the same material or may be made from different materials. Preferably the porous carrier material and the application means are made from a felt or a melamine foam. If the liquid does not include a filler, the application means is preferably a fiber material, more particularly a felt. If the liquid includes a filler, the application means is preferably a sponge, more particularly of melamine foam. In order to be able effectively to distinguish the porous carrier material and the application means in application, they are preferably different in color. Thus, for example, the application means may always be produced in a red color and the porous carrier material always in a yellow color, so that the consumer is immediately aware that a liquid is applied using the red material and is wiped off again using the yellow material.

The application means and the porous carrier material are preferably fixed on the container. Fixing may be accomplished, for example, chemically or mechanically, more particularly by adhesive bonding, clamping, or via nails, screws, barbs or rivets. For example, the application means or the porous carrier material may first be fixed on a molding which in the edge region ensures a bond with the container. This bond is preferably made via a screw connection via a thread.

In one embodiment the liquid is introduced directly into the filling chamber of the container. In this embodiment the container is composed preferably of a stable material such as, for example, of a metal, a rigid plastic, or a composite material, an aluminum-coated plastic for example. Preferably at least the wall and the base of the container are composed of aluminum. The lid is composed preferably of a plastic or of a foil, such as of an aluminum foil, or of a composite aluminum/plastic foil, and for application may either be removed or at least partly opened, by puncturing for example.

In another embodiment the at least one liquid is filled into at least one separate minicontainer which can be introduced into the filling chamber of the container. The at least one minicontainer is preferably fabricated of a material which can be destroyed by the application of pressure, and more particularly which ruptures, bursts or tears, being made, for example, of a brittle material, preferably of glass or of a thin brittle plastic, or a pouch which tears at the seam on exposure to pressure. Particularly suitable for this purpose are aluminum or glass or composite materials or other brittle substances, such as a thin brittle plastic, for example. In this way, for example, the at least one minicontainer may be an aluminum pouch or an aluminum-coated plastic pouch. This kind of material has the advantage that the wall of the minicontainer can be severed all round, and hence that precise positioning of the pouch is not vital.

As a result of exposure to pressure, the at least one minicontainer ruptures or tears, and the liquid is able to emerge into the filling chamber of the container. In this preferred embodiment, the liquid is first sealed in at least one minicontainer, and is able to emerge only through the aperture of the container, after the minicontainer has been breached. Since the minicontainer is located in the interior of the container, the container in this embodiment must be made of material which is deformable, so that the at least one minicontainer can be breached through the container. The container is preferably made of a flexible plastic or cardboard which, though deformable, is still sufficiently stable not to be breached when the at least one minicontainer is ruptured.

The use of a minicontainer in the container itself brings with it the advantage that the aperture of the container need not necessarily be sealed, and that, if required, the requisite liquid can be made available and applied very quickly. Furthermore, more than one minicontainer may be used, such as two or three or more, for example. By this means it is also possible to store different liquids, which mix and—if appropriate—react with one another only after the two or more minicontainers have been destroyed. In this way, for example, two-component systems can be used.

A suitable two-component composition is, for example, a two-component adhesion promoter composition for surface pretreatment, comprising two components, the first component comprising at least one hydrolyzable adhesion promoter substance selected from the group encompassing organosilicon compounds, organotitanium compounds, organozirconium compounds, and mixtures thereof, as described below. The second component further comprises at least one compound which reacts with the adhesion promoter substance or which initiates or catalyzes condensation of the adhesion promoter substance—for example, a catalyst as described below for the adhesion promoter composition, more particularly an organotin compound or an acid.

In the unopened state, the first and second components are present in two chambers which are separated from one another by at least one partitioning wall, as for example in two minicontainers, and, after the two minicontainers have been opened, are mixed in the filling chamber of the container of the means of the invention, before the mixed composition is applied to at least one substrate surface. Mixing may be assisted by shaking. The container may further comprise a mixing element, in the form for example of one or more balls as a mixing aid, in order to effect thorough mixing of the at least two components. The ball may if necessary be provided with points or edges in order to facilitate tearing or destruction of the partitioning wall. The nature and thickness of the partitioning wall and also the amount and surface design of the balls used should be chosen such that the partitioning wall can be destroyed by simple shaking of the pack, but does not occur unintentionally, such as on just small vibrations of the kind which occur on transportation.

Subsequently the adhesion promoter composition thus-prepared is applied to a surface where adhesive bonding or sealing is to take place. Depending on the nature of the constituents chosen in the first or second component it may be necessary to wait for a short time of typically less than half an hour to elapse between the opening of the at least two minicontainers, and hence the contacting of the two components, and the application to a substrate surface, in order to achieve optimum adhesion promoter activity. Preferably, however, the adhesion promoter composition is applied immediately.

By “liquid” is meant throughout the present text a composition which flows and which has a viscosity of less than 1000 mPa*s, preferably less than 500 mPa*s, more preferably of less than 100 mPa*s. Particularly suitable in accordance with the present invention are liquids which are of low viscosity and have a dynamic viscosity of less than 100 mPa*s, preferably up to about 10 to 60 mPa*s. Solids-free liquids are particularly preferred. However, liquids which include particulate solids, such as carbon black, for example, are also suitable. The liquid is preferably a solution, an emulsion, a suspension or a dispersion, a paste for example. In the case of a suspension or dispersion, the stability is an important feature. The stability can be controlled by the person skilled in the art by means, for example, of varying solvent, concentrations, operating parameters during preparation, or by using suitable additives, more particularly surfactants, emulsifiers, coemulsifiers or stabilizers. The liquid may be, for example, a cleaning product or an adhesion promoter.

Liquids particularly suitable are adhesion promoter compositions, more particularly adhesion promoter compositions comprising at least one hydrolyzable adhesion promoter substance, more particularly comprising or consisting of a silane, titanate and/or zirconium compound.

The at least one hydrolyzable adhesion promoter substance may be an organosilicon compound. Suitable in principle are all organosilicon compounds known to the person skilled in the art that are used as adhesion promoters. This organosilicon compound preferably carries at least one, more particularly at least two, alkoxy groups, which is or are attached directly to a silicon atom via an oxygen-silicon bond. The organosilicon compound additionally carries at least one substituent which is attached to the silicon atom via a silicon-carbon bond, and which optionally contains a functional group which is selected from the group encompassing oxirane, hydroxyl, (meth)acryloyloxy, amino, mercapto, and vinyl group.

Particularly suitable organosilicon compounds are organosilicon compounds of the formulae formula (I) or (II) or (III)

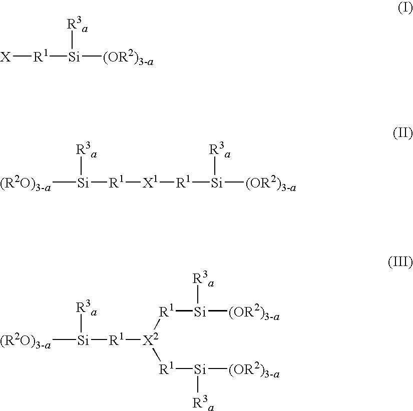

R¹ here stands for a linear or branched, optionally cyclic, alkylene group having 1 to 20 C atoms, optionally with aromatic fractions, and optionally with one or more heteroatoms, more particularly nitrogen atoms.

R² here stands for an alkyl group having 1 to 5 C atoms, more particularly for methyl or ethyl, or an acyl group.

R³ here stands for an alkyl group having 1 to 8 C atoms, more particularly methyl.

X here stands for an H, or a functional group which is selected from the group encompassing oxirane, OH, (meth)acryloyloxy, amine, SH, acylthio, and vinyl, preferably amine. For the sake of completeness it is mentioned that acylthio in this document means the substituent

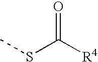

where R⁴ stands for alkyl, more particularly having 1 to 20 carbon atoms, and the dashed line represents the bond to the substituent R¹.

X¹ here stands for a functional group which is selected from the group encompassing NH, S, S₂, and S₄.

X² here stands for a functional group which is selected from the group encompassing N and isocyanurate.

a here stands for one of the values 0, 1 or 2, preferably 0.

The substituent R¹ denotes more particularly a methylene, propylene, methylpropylene, butylene or dimethylbutylene group. Particularly preferred as substituent R¹ is a propylene group.

Organosilicon compounds containing amino, mercapto or oxirane groups are also referred to as “aminosilanes”, “mercaptosilanes”, or “epoxysilanes”.

Examples of suitable organosilicon compounds of the formula (I) are the organosilicon compounds selected from the group encompassing octyltrimethoxysilane, dodecyltrimethoxysilane, hexadecyltrimethoxysilane, methyloctyidimethoxysilane; 3-glycidyloxypropyltrimethoxysilane, 3-glycidyloxypropyltriethoxysilane; 3-methacryloyloxypropyltrialkoxysilanes, 3-methacryloyloxypropyltriethoxysilane, 3-methacryloyloxypropyltrimethoxysilane; 3-aminopropyltrimethoxysilane, 3-aminopropyltriethoxysilane, 3-aminopropyldimethoxymethylsilane, 3-amino-2-methylpropyltrimethoxysilane, N-(2-aminoethyl)-3-aminopropyltrimethoxysilane, N-(2-aminoethyl)-3-aminopropyltriethoxysilane, N-(2-aminoethyl)-3-aminopropyldimethoxymethylsilane, 4-aminobutyltrimethoxysilane, 4-aminobutyidimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethylthimethoxysilane, aminomethyldimethoxymethylsilane, aminomethylmethoxydimethylsilane, 7-amino-4-oxaheptyldimethoxymethylsilane, N-(methyl)-3-aminopropyltrimethoxysilane, N-(n-butyl)-3-aminopropyltrimethoxysilane; 3-mercaptopropyltriethoxysilane, 3-mercaptopropyltrimethoxysilane, 3-mercaptopropylmethyldimethoxysilane; 3-acylthiopropyltrimethoxysilane; vinyltrimethoxysilane and vinyltriethoxysilane.

Also preferred are the organosilicon compounds as just mentioned whose alkoxy groups have been replaced by acetoxy groups, such as octyltriacetoxysilane (octyl-Si(O(O═C)CH₃)₃), for example. Organosilicon compounds of this kind give off acetic acid on hydrolysis.

Preferred among these stated organosilicon compounds are those which have an organic substituent attached to the silicon atom that additionally contains a functional group as well, i.e., that is not an alkyl group, and conform to a formula (I) in which X is not H.

Examples of suitable organosilicon compounds of the formula (II) are the organosilicon compounds selected from the group encompassing bis[3-(trimethoxysilyl)propyl]amine, bis[3-(triethoxysilyl)propyl]amine, 4,4,15,15-tetra-ethoxy-3,16-dioxa-8,9,10,11-tetrathia-4-15-disilaoctadecane(bis(triethoxysilylpropyl)polysulfide or bis(triethoxysilylpropyl)tetrasulfane), bis(triethoxysilylpropyl)disulfide.

Examples of suitable organosilicon compounds of the formula (III) are the organosilicon compounds selected from the group encompassing tris[3-(trimethoxysilyl)propyl]amine, tris[3-(triethoxysilyl)propyl]amine, 1,3,5-tris[3-(trimethoxysilyl)propyl]-1,3,5-triazine-2,4,6(1H,3H,5H)trione-urea (i.e., tris(3-(trimethoxysilyl)propyl)isocyanurate), and 1,3,5-tris[3-(triethoxysilyl)propyl]-1,3,5-triazine-2,4,6(1H,3H,5H)trione-urea (i.e., tris(3-(triethoxysilyl)propyl)isocyanurate).

Preferred organosilicon compounds are aminosilanes, more particularly aminosilanes with X═NH₂ or NH₂—CH₂—CH₂—NH, X¹═NH, and X²═N. Particular preference is given to 3-aminopropyltrimethoxysilane, N-(2-aminoethyl)-3-aminopropyltrimethoxysilane, bis[3-(trimethoxysilyl)propyl]amine, 3-aminopropyltriethoxysilane, N-(2-aminoethyl)-3-aminopropyltriethoxysilane, and bis[3-(triethoxysilyl)propyl]amine, and also to their mixtures with one another. It has emerged that, more particularly with aminosilanes, especially in the case of the aminosilanes mentioned in this section, the microcracking of the thermally cured silicone coating is reduced.

The at least one hydrolyzable adhesion promoter substance may additionally be an organotitanium compound. Suitable in principle are all organotitanium compounds known to the person skilled in the art that are used as adhesion promoters.

Of more particular suitability are organotitanium compound which carries at least one functional group which is selected from the group encompassing alkoxy group, sulfonate group, carboxylate group, dialkyl phosphate group, dialkyl pyrophosphate group, and acetylacetonate group, or mixtures thereof, and which is attached directly to a titanium atom via an oxygen-titanium bond.

Particularly suitable compounds are those in which all of the substituents attached to the titanium are selected from the group encompassing alkoxy group, sulfonate group, carboxylate group, dialkyl phosphate group, dialkyl pyrophosphate group, and acetylacetonate group, it being possible for all of the substituents to be identical or different from one another.

Having proven particularly suitable as alkoxy groups are, more particularly, those substituents known as neoalkoxy substituents, more particularly of the formula (IV) below

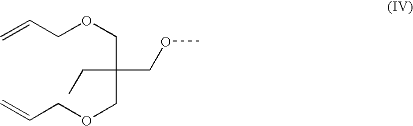

Having proven particularly suitable as sulfonic acids are, more particularly, aromatic sulfonic acids whose aromatics are substituted by an alkyl group. Considered preferred sulfonic acids are radicals of the formula (V) below

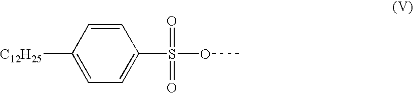

Having proven particularly suitable as carboxylate groups are, more particularly, carboxylates of fatty acids. Decanoate is considered to represent preferred carboxylates.

In the formulae (IV) and (V) above, the dashed bond indicates the oxygen-titanium bond.

Organotitanium compounds are available commercially, from the company Kenrich Petrochemicals or DuPont, for example. Examples of suitable organotitanium compounds are, for example, Ken-React® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA 01, LICA 09, LICA 12, LICA 38, LICA 44, LICA 97, LICA 99, KR OPPR, KR OPP2 from Kenrich Petrochemicals or Tyzor® ET, TPT, NPT, BTM, AA, AA-75, AA-95, AA-105, TE, ETAM, OGT from DuPont. Considered preferred are Ken-React® KR 7, KR 9S, KR 12, KR 26S, KR 38S, KR44, LICA 09, LICA 44, NZ 44, and also Tyzor® ET, TPT, NPT, BTM, AA, AA-75, AA-95, AA-105, TE, ETAM from DuPont.

Particularly preferred are organotitanium compounds having substituents of the formulae (IV) and/or (V) attached to the titanium atom via an oxygen-titanium bond.

The at least one hydrolyzable adhesion promoter substance may additionally be an organozirconium compound. Suitability is possessed in principle by all of the organozirconium compounds known to the person skilled in the art that are used as adhesion promoters. Suitable more particularly are organozirconium compounds which carries at least one functional group which is selected from the group encompassing alkoxy group, sulfonate group, carboxylate group, phosphate group or mixtures thereof, and which is attached directly to a zirconium atom via an oxygen-zirconium bond.

Alkoxy groups having proven particularly suitable are, more particularly, isopropoxy substituents and those substituents known as neoalkoxy substituents, more particularly of the formula (IV) as described above, the dashed bond here indicating the oxygen-zirconium bond.

Having proven particularly suitable as sulfonic acids are, more particularly, aromatic sulfonic acids whose aromatics are substituted by an alkyl group. Considered preferred sulfonic acids are radicals of the following formula (V) as described above, the dashed bond here indicating the oxygen-zirconium bond.

Carboxylate groups which have proven particularly suitable are, more particularly, carboxylates of fatty acids. Stearates and isostearates are considered preferred carboxylates.

Organozirconium compounds are available commercially, from the company Kenrich Petrochemicals, for example. Examples of suitable organozirconium compounds are, for example, Ken-React® NZ 38J, NZ TPPJ, KZ OPPR, KZ TPP, NZ 01, NZ 09, NZ 12, NZ38, NZ 44, NZ 97.

The adhesion promoter substance of the composition of the invention may further comprise mixtures of at least one organosilicon compound with at least one organotitanium compound and/or with at least one organozirconium compound. Also possible are mixtures of at least one organotitanium compound with at least one organozirconium compound. Preferred mixtures are those of at least one organosilicon compound with at least one organotitanium compound.

Particularly preferred mixtures are those of two or more organosilicon compounds or mixtures of one organosilicon compound with one organotitanium compound, or organozirconium compound, respectively.

Of proven suitability as mixtures of organosilicon compounds are, in particular, mixtures of adhesion promoter substances of the formulae (I), at least one of these substituents carrying H as substituent X, and at least one of these substances carrying a functional group which is selected from the group encompassing oxirane, (meth)acryloyloxy, amine, SH, and vinyl, as substituent X. These mixtures are preferably mixtures of at least one alkyltrialkoxysilane with an aminoalkyltrialkoxysilane and/or mercaptoalkyltrialkoxysilane.

The adhesion promoter composition may comprise further constituents besides the hydrolyzable adhesion promoter substances described. A suitable further constituent, for example, is at least one solvent. More particularly, mixtures of different solvents are advantageous. It has emerged as being particularly suitable if mixtures of hydrocarbons with one another or mixtures of at least one hydrocarbon with at least one polar solvent that contains at least one heteroatom in its structural formula are used. The hydrocarbon may be saturated or olefinically or aromatically unsaturated. Preferably the hydrocarbon is saturated. Considered suitable as the heteroatom in the polar solvent are, more particularly, O, N, and S. Preferably the at least one heteroatom is an oxygen atom, which with particular preference is present in the form of hydroxyl, carbonyl, ether, carboxylic acid or carboxylic acid derivative groups, such as ester, amide or carboxylate group, for example, in the structural formula of the polar solvent.

Preferred polar solvents are water, alcohols, and ketones. Most-preferred polar solvents are alcohols, more particularly saturated, branched or linear or cyclic alcohols having 1 to 8 carbon atoms, preferably methanol, ethanol, propanol, isopropanol, butanol, higher alcohols, such as ethylene glycol, glycerol, polyether polyols such as polyethylene glycols and ether alcohols, such as butyl glycol, methoxypropanol, and alkylpolyethylene glycols.

Also suitable are aldehydes, esters, ethers, amides or ketones, more particularly acetone, methyl ethyl ketone, hydrocarbons, especially methyl esters, ethyl esters, isopropyl esters, heptane, hexane, cyclohexane, xylene, toluene, octane, white spirit, and mixtures thereof. Ethyl acetate, ethanol, isopropanol or heptane, and also mixtures of these, are considered to be preferred.

Likewise suitable are mixtures of water with alcohols having a water fraction of more than 50%, preferably more than 65%, in particular more than 80%, by weight.

Considered particularly preferred are solvent mixtures of an alcohol and of an aliphatic or cycloaliphatic hydrocarbon. More particularly those of ethanol or isopropanol with hexane or cyclohexane or heptane or octane, and also mixtures thereof. A solvent mixture which has emerged as being particularly preferred is the mixture of ethanol and heptane.

Using a solvent of this kind it is possible to ensure that homogeneously small concentrations of adhesion promoter substances, i.e., of organosilicon compound and/or organotitanium compound, can be applied to a surface. The solvent content is preferably chosen such that the organosilicon compound and/or organotitanium compound content is from 0.01% to 10% by weight, more particularly between 0.5% to 10% by weight.

A further component that may be present in the adhesion promoter composition is a reactive or nonreactive binder. Particularly suitable reactive binders are, more particularly, polyurethane prepolymers with isocyanate groups and/or silane groups; or there may be polyisocyanates present, for example, tris(4-isocyanatophenyl)methane, tris(4-isocyanatophenyl)thio-phosphate, the aforementioned monomeric MDI, TDI, HDI, and IPDI, and also oligomers, polymers or copolymers of these monomers, such as polymeric HDI, polymeric MDI, available commercially for example as Voranate® M 229 (Dow), Desmodur® VL R 20 (Bayer), or allophanates, biurets, uretdiones, and isocyanurates of these monomers, more particularly HDI biurets, as, for example, available commercially as Desmodur® N-100 (Bayer), Luxate® HDB 9000 (Lyondell/Bayer), HDI trimers, as, for example, available commercially as Desmodur® N-3300 (Bayer), Desmodur® N-3600 (Bayer), Luxate® HT 2000 (Lyondell/Bayer), Desmodur® XP 2410, HDI dimers, as, for example, available commercially as Desmodur® N-3400 (Bayer), Luxate® HD 100 (Lyondell/Bayer), IPDI trimers, as, for example, available commercially as Desmodur® Z 4470 (Bayer), Vestanat® T 1890 (Degussa), Luxate® IT 1070 (Lyondell/Bayer), HDI and IPDI allophanates, TDI trimers, as, for example, available commercially as Desmodur® IL (Bayer), TDI adducts, as, for example, available commercially as Desmodur® L (Bayer), TDI/HDI polymers, as, for example, available commercially as Desmodur® HL (Bayer), Polurene® IK D (Sapici), Hartben AM 29 (Benasedo).

Particularly suitable non-reactive binders are binders based on epoxy resin or on polyacrylate.

Likewise useful as a constituent of the adhesion promoter composition are catalysts for the hydrolysis, for example, of silane groups, and specifically, for example, in the form of organic carboxylic acids such as benzoic acid or salicylic acid, organic carboxylic anhydrides such as phthalic anhydride or hexahydrophthalic anhydride, silyl esters of organic carboxylic acids, organic sulfonic acids such as p-toluenesulfonic acid or 4-dodecylbenzenesulfonic acid, or other organic or inorganic acids, or mixtures of the aforementioned acids; and also catalysts for the reaction of isocyanate groups, examples being tin compounds such as tin(II)octoate, monobutyltin trichloride, dibutyltin dichloride, dibutyltin oxide, dibutyltin diacetate, dibutyltin dilaurate, dibutyltin diacetylacetonate, dibutyltin dicarboxylates, dioctyltin dicarboxylates, alkyltin thioesters, bismuth compounds such as bismuth(III)octoate, bismuth(III)neodecanoate, zinc compounds such as zinc(II)octoate, and also compounds containing amino groups, such as, for example, 2,2′-dimorpholinodiethyl ether, 1,4-diazabicyclo[2.2.2]octane, 1,8-diazabicyclo[5.4.0]undec-7-ene; and also other catalysts such as titanates and zirconates.

In addition it is possible to use additives, fillers, and wetting agents that are typical in primer chemistry. Examples, of nonlimiting nature, thereof are talc, carbon black, fumed silicas, chalks, their surfaces modified if need be, organic and inorganic pigments, stabilizers, flow control agents, defoamers, surfactants, biocides, antisettling agents, inhibitors, dyes, anticorrosion agents, odorants, and also chemical and physical driers.

Likewise suitable as further constituents are UV absorbers and also optical brighteners. Such optical brighteners absorb UV light and emit visible light, normally blue light. One preferred optical brightener is Ciba Uvitex® OB from Ciba Speciality Chemicals. Further suitable brighteners are specified in Kirk-Othmer, “Encyclopedia of Chemical Technology” 4th Ed., John Wiley & Sons, New York, vol. 11, pp. 227-241, for example. The UV absorbers may for example be organic in nature, such as those from the Tinuvin® product line from Ciba Speciality Chemicals, for example, or they may be inorganic in nature, such as color pigments, for example, more particularly carbon black or titanium dioxide.

Likewise suitable for applying and wiping off with the means of the invention is a liquid which comprises or consists of a cleaning product. The cleaning product preferably comprises a solvent. Suitable solvents are the same as already described above for the adhesion promoter composition. Preferably the solvent is water or alcohol, more particularly ethanol or heptane.

The cleaning product further comprises, preferably, a wetting agent. Particularly suitable wetting agents are anionic surfactants, especially alkylbenzenesulfonates, or nonionic surfactants, especially ethoxylates. Particularly suitable wetting agents are ethoxylated polysiloxanes, ethoxylated fluorosurfactants, dodecylbenzenesulfonates or nonylphenol ethoxylates.

Additionally the cleaning product may comprise further fillers and additives. Nonlimiting examples thereof are adhesion promoters, talc, carbon black, fumed silicas, silicates, chalks, organic and inorganic pigments, stabilizers, flow control agents, defoamers, surfactants, biocides, antisettling agents, inhibitors, dyes, anticorrosion agents, odorants, and also chemical and physical driers.

In one preferred embodiment the cleaning product comprises at least one silica or at least one silicate or mixtures thereof. Particularly preferred are those silicas or silicates which have a Mohs hardness of less than that of glass, preferably less than 7, more preferably less than 6.6, with particular preference less than 6, so that the glass surface or glass ceramic surface is not scratched. Examples of suitable silicas are amorphous or colloidal silicas, such as fumed silicas or silica gel. Particular preference is given to a fumed silica, available for example commercially in the form of Aerosil® from Degussa. The silicates include the salts and esters of orthosilicic acid. Particularly suitable silicates are the phyllosilicates, especially the clay minerals belonging to the class of the phyllosilicates such as, for example, kaolinite, dickite, nacrite, smectites, glauconite, vermiculite or bentonite. Bentonites are particularly preferred. A cleaning product of this kind is used preferably for removing unwanted impurities, more particularly of silicone compounds or oils, which are present as impurities on the surface of a sheet, more particularly on a glass surface or glass ceramic surface.

The means of the invention can also be used to apply more than one liquid simultaneously or to apply a mixture of two or more liquids. For example, the container of the means of the invention may comprise two or more chambers, such as two or more minicontainers, for example. The different chambers may contain the same or different liquids. In one embodiment the chambers may be separated consistently by at least one partitioning wall, with the consequence that, only after emergence from the two or more apertures, they come into contact with one another, where appropriate, on the substrate surface or are mixed. In another embodiment the container comprises two or more minicontainers which can be destroyed, with the consequence that the two or more liquids can be mixed while still in the container before being applied to a substrate surface.

The means of the invention may be used in particular for applying and wiping off a liquid, more particularly an adhesion promoter composition.

The present invention further provides a method of applying and wiping off a liquid, more particularly an adhesion promoter composition, on at-least one substrate surface S1, comprising the steps of

a) applying the liquid with the side bearing the aperture of the means of the invention to a substrate surface S1, and

b) wiping off the liquid with the side bearing the porous carrier material of the means of the invention.

Application and wiping off of the liquid with the means of the invention may take place manually or mechanically, in particular by means of robots.

The substrate on whose surface the liquid is applied may vary greatly. Particular suitability is possessed by inorganic substrates such as glass, glass ceramic, concrete, mortar, brick, tile, plaster, and natural stones such as granite or marble; metals or alloys such as aluminum, steel, nonferrous metals, galvanized metals; organic substrates such as wood, chipboard, plastics such as polyvinyl chloride (PVC), polycarbonates, poly(methyl methacrylate) (PMMA), polyesters, epoxy resins; coated substrates such as powder-coated metals or alloys; and also paints and finishes, more particularly automobile topcoat finishes. The most-preferred substrates are glass, more particularly ceramic-coated glass, painted substrates, such as painted metal flanges, and also plastics, more particularly PVC.

The present invention may be used more particularly in connection with the pretreatment of substrate surfaces which are to be subsequently joined with an adhesive or sealant. Suitable applications are therefore, for example, the adhesive bonding of components in construction or civil engineering and in the manufacture or repair of industrial goods or consumer goods, more particularly windows, household machines or means of transport such as water or land vehicles, preferably automobiles, buses, trucks, trains or boats; the sealing of joints, seams or cavities in industrial manufacture or repair, or in construction or civil engineering. The present invention is particularly suitable in connection with the application of an adhesion promoter substance to a sheet, preferably of glass, where the sheet is to be joined with at least one further substrate of glass, wood, coating material, or plastic, more particularly polyvinyl chloride (PVC), more particularly by adhesive bonding. Accordingly the method of the invention can be employed preferably in vehicle construction, where glass is bonded with a paint-coated body, or in door or window construction, where glass is bonded with a frame made of wood or plastic.

The invention further provides a method of adhesively bonding and/or sealing at least two substrate surfaces S1 and S2, comprising the steps of: (a) applying and wiping off an adhesion promoter composition, using an above-described means, to a substrate S1 and/or a substrate S2; (b) applying an adhesive or sealant to at least one substrate surface S1 and/or S2 or between the substrates S1 and S2; optionally (c) contacting the substrates S1 and S2 via the adhesive or sealant applied; and (d) curing the applied adhesive or sealant; the substrates S1 and S2 being alike or different from one another.

In its use as a sealant, the composition is applied between the substrates S1 and S2, and then curing takes place. Typically the sealant is injected into a joint.

The application of the adhesive or sealant takes place preferably uniformly.

In both applications the substrate S1 may be alike or different from substrate S2.

Examples of suitable substrates S1 or S2 are inorganic substrates such as glass, glass ceramic, concrete, mortar, brick, tile, plaster, and natural stones such as granite or marble; metals or alloys such as aluminum, steel, nonferrous metals, galvanized metals; organic substrates such as wood, plastic such as polyvinyl chloride (PVC), polycarbonates, poly(methyl methacrylate) (PMMA), polyesters, epoxy resins; coated substrates such as powder-coated metals or alloys; and also paints and finishes, more particularly automobile topcoat finishes.

It has emerged that polyurethane adhesives, (meth)acrylate adhesives, epoxy resin adhesives or adhesives based on alkoxysilane-functional prepolymers are extremely suitable for adhesive bonding.

Suitable polyurethane adhesives are, on the one hand, one-component moisture-curing adhesives or two-component polyurethane adhesives. Adhesives of this kind comprise polyisocyanates, more particularly in the form of prepolymers containing isocyanate groups. Preference is given to polyurethane adhesives of the kind sold commercially by Sika Schweiz AG under the product lines Sikaflex®, SikaPower®, and SikaForce®.

(Meth)acrylate adhesives are two-component adhesives whose first component comprises acrylic acid and/or methacrylic acid and/or esters thereof and whose second component comprises a free-radical initiator, more particularly a peroxide. Preferred such adhesives are available commercially under the product lines SikaFast® from Sika Schweiz AG.

Epoxy resin adhesives are adhesives which are formulated on the basis of glycidyl ethers, more particularly of diglycidyl ether of bisphenol A and/or bisphenol F. Particularly suitable two-component epoxy resin adhesives are those whose one component comprises diglycidyl ethers of bisphenol A and/or bisphenol F and whose second component comprises polyamines and/or polymercaptans. Preference is given to two-component epoxy resin adhesives of the kind available commercially under the product line Sikadur® from Sika Schweiz AG. Having emerged as being particularly suitable for the adhesive bonding of films are the two-component epoxy resin adhesives Sikadur® Combiflex®, Sikadur® 31, Sikadur® 31DW, and Sikadur® 33, preferably Sikadur® Combiflex®, from Sika Schweiz AG.

Adhesives based on alkoxysilane-functional prepolymers are, more particularly, adhesives based on MS polymers or SPUR (silane-terminated polyurethanes) prepolymers. Alkoxysilane-functional prepolymers of this kind can be prepared, for example, by way of a hydrosilylation reaction from polyethers containing at least two C═C double bond, more particularly from allyl-terminated polyoxyalkylene polymers, and with a hydrosilane, or by way of an addition reaction of isocyanatoalkylalkoxysilanes with polyols or with hydroxyl-functional polyurethane prepolymers, or via an addition reaction of aminoalkylalkoxysilanes with isocyanate-functional polyurethane prepolymers, the polyurethane prepolymers themselves being accessible via a reaction of polyisocyanates and polyols and/or polyamines in a known way. Adhesives based on alkoxysilane-functional prepolymers are moisture-curing and react at room temperature.

In principle it is also possible to use reactive hot-melt adhesives, of the kind sold commercially by Sika Schweiz AG under the product line SikaMelt®. Preference, however, is given to room-temperature-curing adhesives.

If required, prior to the applying of the adhesive or sealant, the substrates may additionally be pretreated for the application of an adhesion promoter composition. Besides the application of an adhesion promoter, an adhesion promoter solution or a primer, pretreatments of this kind encompass, more particularly, physical and/or chemical cleaning methods, examples being abrading, sandblasting, brushing or the like, or treatment with cleaners or solvents.

The adhesive bonding or sealing of the substrates S1 and S2 in accordance with a method of the invention produces an adhesively bonded or sealed article. An article of this kind may be a built structure, more particularly a built structure of construction or civil engineering, or a means of transport. Preferably the article is a means of transport, such as a water or land vehicle, for example, more particularly an automobile, a bus, a truck, a train or a boat, or a component for installation thereon. With particular preference the adhesively bonded or sealed article is a means of transport, more particularly an automobile, or a component for installation on a means of transport, more particularly an automobile.

Accordingly the means of the invention is especially suitable for the simple application and wiping off of a liquid on a substrate surface. The means of the invention simplifies the work cycle and reduces the level of consumption of material, since one means can be used to carry out the two work steps of applying and wiping off, and there is no need for an additional cloth or sponge in a further workstep. For each step, in other words both for the application and for the wiping, clean material is present, and there is no need, following application, to search laboriously for a clean material for the wiping off. The means of the invention is especially suitable for single-use applications, especially for refinish applications in the vehicle sector.

The possible and preferred embodiments of the means of the invention are described schematically below.

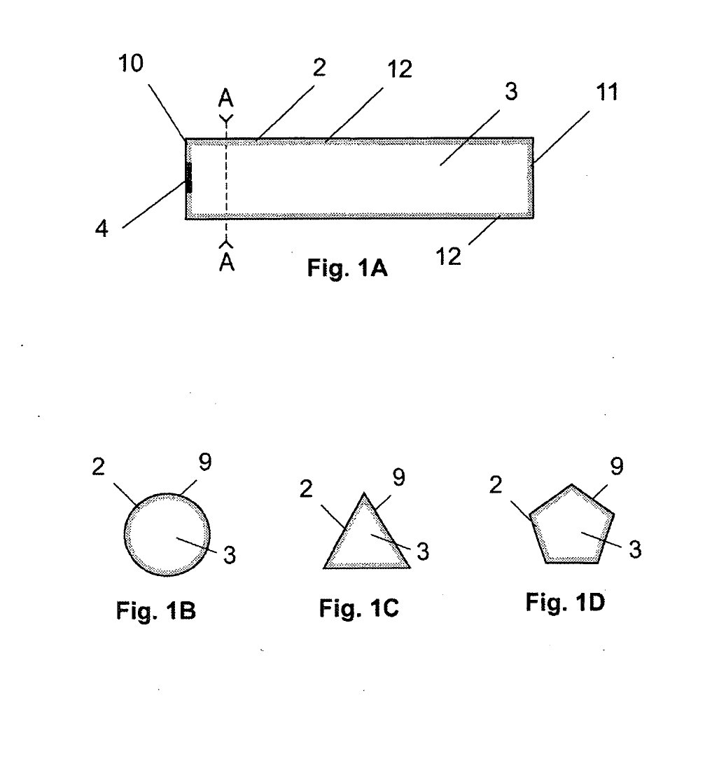

FIG. 1A shows a diagrammatic representation of a longitudinal section through a container 2 which is suitable for the means of the invention for applying and wiping off a liquid. Shown here as an example is a container 2 which comprises a lid 10, a base 11, and two side walls 12. The two side walls 12 are, for example, part of a casing, such as in the case of a pot or a tube, for example. In FIG. 1A the lid 10, the base 11, and the side walls 12 are shown in one piece. Alternatively they can be made individually and may be made of different materials. The lid 10 comprises at least one aperture 4. Alternatively the lid 10 may be fixed as a separate part to the side of the container 2 that contains at least one aperture 4, so that the aperture is closed and the liquid does not emerge unintentionally. To apply the liquid to a substrate surface, the lid can be removed, by being torn off or pulled away, for example. Through this at least one aperture 4, the liquid is able to emerge from the container 2 and be applied to a substrate surface. The outer side 9 of the container is likewise 2 shown. FIG. 1A shows only one embodiment of a container 2, and not the means of the invention for applying and wiping off a liquid, which would additionally comprise a porous carrier material for wiping off the liquid as well.

FIGS. 1B, 1C and 1D show different contours of a container 2. A section is shown along the line A-A through the container 2 of FIG. 1A.

In FIG. 1B the container 2 is of hollow-cylindrical design. The filling chamber 3 is encased by the container 2, which has an outer side 9. The cross section is circular.

In FIG. 1C the cross section through the container 2 is triangular, while in FIG. 1D it is pentangular.

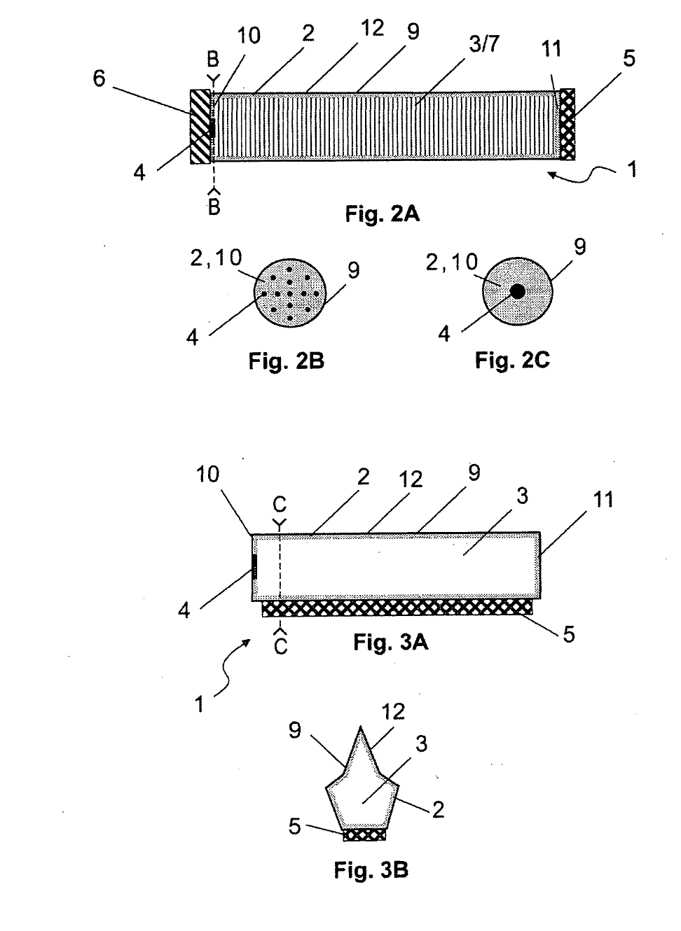

FIG. 2A shows a diagrammatic representation of a longitudinal section through a means 1 of the invention which is suitable for applying and wiping off a liquid 7. In addition to the container as shown in FIG. 1A, FIG. 2A shows the porous carrier material 5, which is mounted on the outer side 9 of the container 2 and which is located on the side opposite the at least one aperture, i.e., on the base 11. In this representation the filling chamber 3 is filled with liquid 7. In this embodiment the aperture 4 is covered by an application means 6, preferably by a sponge or felt. Either the application means 6 can be mounted on the aperture during the production of the container 2, or the container 2 may be sold, for example, without application means 6, and the application means 6 can be mounted on the aperture 4 a short time prior to use, where appropriate following removal of a lid. The liquid 7 impregnates the felt or sponge 6 and can be applied to a surface by means of contact between the application means 6 and a surface.

FIGS. 2B and 2C show a section along the line B-B through the side bearing the aperture 4, in this case through the lid 10 of the container 2. In FIG. 2B the lid 10 has a plurality of apertures 4. In FIG. 2C the lid 10 has one aperture 4. The aperture may be, for example, a small hole or, if a paste is used for example, may be a relatively large hole with a diameter of 0.1 mm to 10 mm, for example.

FIG. 3A shows a diagrammatic representation of a longitudinal section through a second embodiment of a means 1 of the invention. In contradistinction to the means shown in FIG. 2A, the means shown in FIG. 3A has a porous carrier material 5, which is mounted on the outer side 9 of the container 2 which is located on the side bordering the at least one aperture, in other words on the side wall or on the casing. The base 11 does not have any porous carrier material 5, and no application means 6 is mounted on the aperture 4. The liquid 7 is not shown.

FIG. 3B shows a section along the line C-C through the container 2 of FIG. 3A. The container 2 preferably has an angular shape, which allows the container to be grasped. On the side opposite the porous carrier material, the container has a bulge, a pointed bulge for example, which allows the container to be grasped and the liquid to be wiped off simply-from a surface. For ease of handling it is sufficient for the container to have a bulge for grasping at least over part of its length. The bulge need not be present over the entire length of the container. The bulge may also serve to allow the liquid to be extruded from the aperture. This can be accomplished in particular if the container 2 is made of an elastic, deformable material. To grasp the container 2 it is also possible additionally for there to be a mount, for example a clip holder, on the container 2.

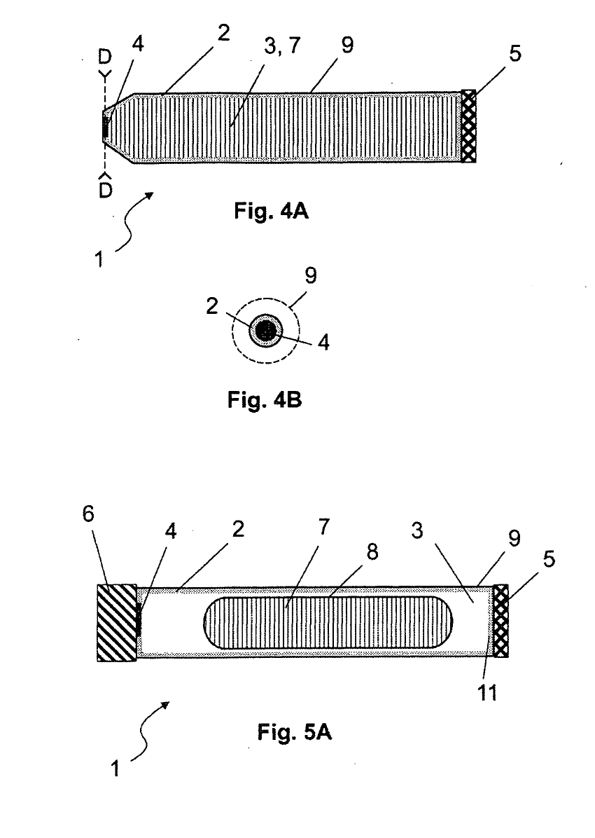

FIG. 4A shows a diagrammatic representation of a longitudinal section through a third embodiment of a means 1 of the invention. In contradistinction to the means shown in FIG. 3A, the means shown in FIG. 4A has a tube form, with a porous carrier material 5 on the base 11. In this embodiment the liquid 6 is, for example, a paste, which can be extruded from the aperture 4 by exertion of pressure on the tube.

FIG. 4B shows a section along the line D-D through the aperture 4 of FIG. 4A. The dashed line 9 represents the outer side 9 of the tube, which is located in a lower plane than the section D-D.

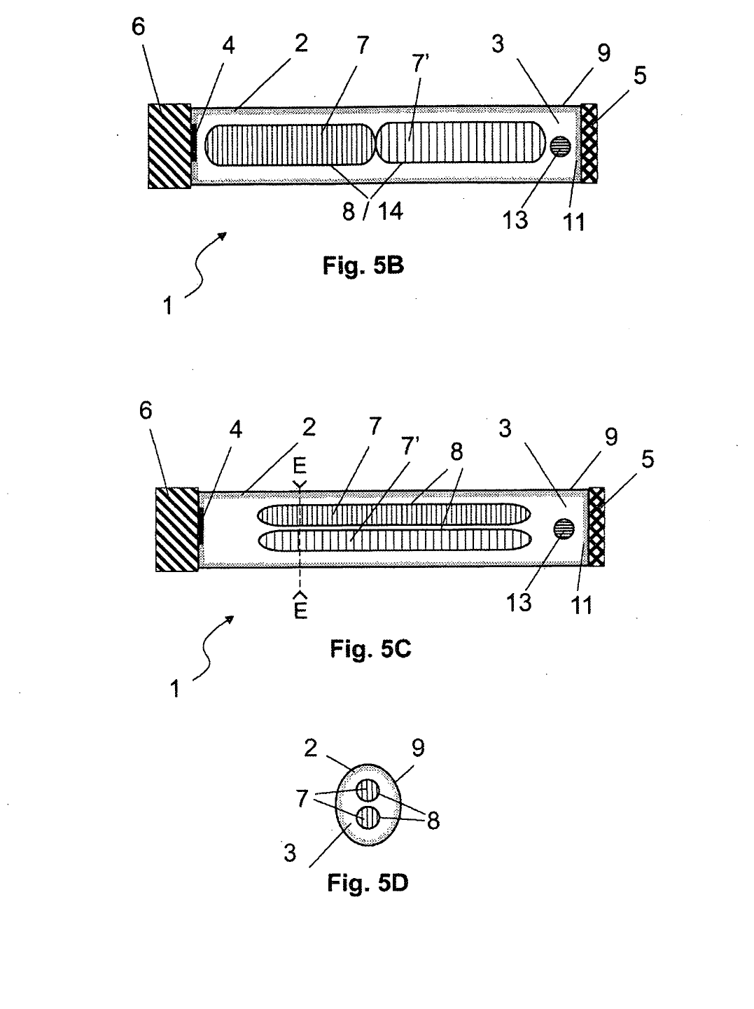

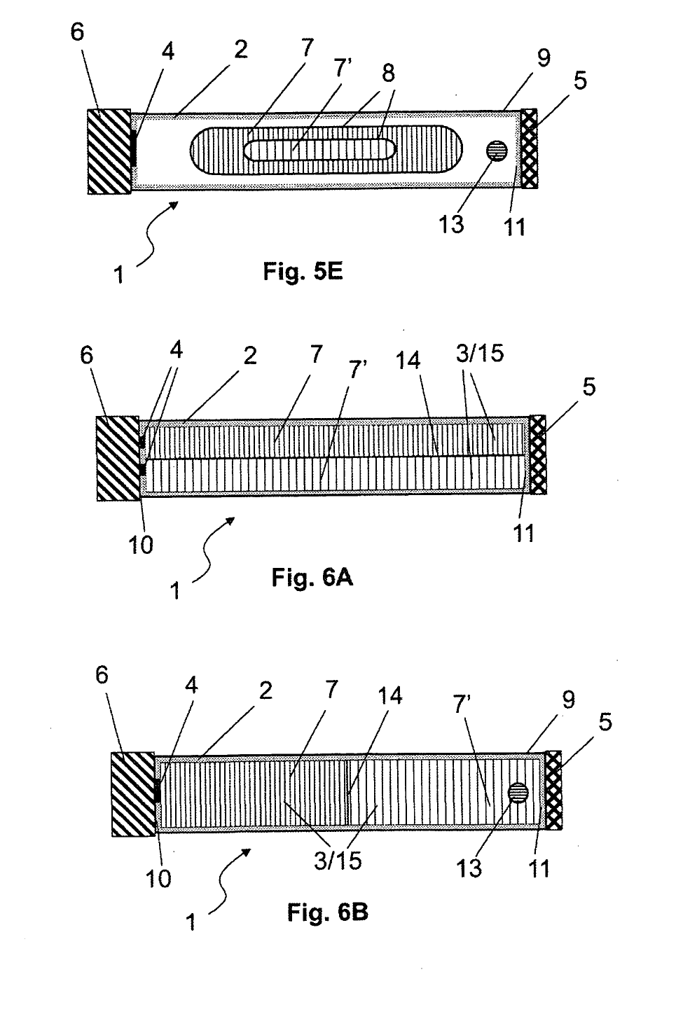

FIG. 5A shows a preferred embodiment of a means 1 of the invention. In this embodiment the liquid 7 is located in a minicontainer 8 which is located in the filling chamber 3 of the container 2. The minicontainer 8 is, for example, a fragile glass or plastic ampoule or a plastic or composite-material pouch. The minicontainer 8 is disposed preferably in a tubular arrangement or, as shown, in an ampoule arrangement. This ampoule arrangement is recessed in a container 2 whose outside walls 9 are fabricated from flexible plastic or cardboard. Moreover, this plastic container 2 has an aperture 4 which is covered by an application means 6, more particularly by a felt strip or a sponge. When the pack is activated, by bending of the outside walls 9 or by striking on the outside walls 9 of the container 2, made of plastic or cardboard, the glass ampoules are broken open, and so the liquid 7 flows into the container 2. The liquid 7 emerges through the aperture 4 and impregnates the felt or sponge 6, and can be applied by means of contact thereof with a surface. The felt or sponge prevents any splinters that might originate from the broken ampoule from emerging from the container 2. To wipe off the liquid 7 from a substrate surface, the means 1 in this embodiment has a porous carrier material 5 on the base 11, i.e., on the side opposite the aperture 4. This embodiment represents in particular a single-use pack for the application and wiping of a liquid. It is especially suitable for small quantities. More particularly this pack is suitable for pretreating a vehicle glazing sheet, more particularly an automobile glazing sheet.

FIG. 5B shows a further preferred embodiment of the means 1 of the invention as already described in FIG. 5A. In contradistinction to the means 1 in FIG. 5A, the means 1 of the invention shown in FIG. 5B has a container 2 with two minicontainers 8, arranged in series. The two minicontainers 8 contain two different liquids, preferably a first component 7 and a second component 7′. When the pack is activated, by bending of the outside walls 9 or by striking on the outside walls 9 of the container 2, made of plastic or cardboard, the partitioning walls 14 of the minicontainers 8 are ruptured, and so the two components 7 and 7′ are able to mix and/or react with one another. Mixing may be assisted by shaking. The container may further comprise an element for mixing, such as one or more balls 13, for example, as a mixing aid, to allow effective mixing of the at least two components 7, 7′. Where necessary the ball 13 may be provided with points or edges to facilitate tearing or destruction of the partitioning wall 14 of the minicontainers 8. The thickness and nature of the partitioning wall 14 of the minicontainers 8, and also the amount and surface design of the balls used, should be chosen such that the partitioning wall 14 can be destroyed by simple shaking of the pack, but not unintentionally, as in the case even of small vibrations of the kind which occur during transportation. The reaction mixture formed from the first and second components 7 and 7′ emerges through the at least one aperture 4 and impregnates the felt or sponge 6.

FIG. 5C shows a further preferred embodiment of the means 1 of the invention as already described in FIGS. 5A and 5B, but with two minicontainers 8 disposed alongside one another.

FIG. 5D shows a cross section along the line E-E through the container 2 of FIG. 5C. In this embodiment the container 2 has an oval cross section, which is especially advantageous when the two minicontainers 8 are disposed alongside one another.

FIG. 5E shows a further preferred embodiment of the means 1 of the invention as already described in FIGS. 5A and 5B, but with two minicontainers 8 which are disposed inside one another—that is, for example, in an ampoule-in-ampoule arrangement or in a pouch-in-pouch arrangement.

FIG. 6A shows a further embodiment of a means 1 of the invention. In this embodiment the filling chamber 3 of the container 2 contains two chambers 15, filled with two different liquids 7 and 7′. The two chambers are separated from one another by a partitioning wall 14. The partitioning wall 14 separates the filling chamber 3 of the container 2 in the lengthwise direction. Each chamber 15 of the container 2 has an aperture 4, which is preferably closed with a lid 10 prior to use of the means of the invention, so that the liquid does not emerge unintentionally. For the use of the means 1 of the invention, the lid 10 is removed or punctured, and an application means 6, in particular a felt strip or a sponge, is fixed to the side of the container 2 that bears the two apertures 4. It is also possible for the application means 6 to be already fixed on the side of the container 2 that bears the two apertures 4, right from the start, and for the lid 10, a tab for example, to be pulled out, thus opening the apertures 4. The two liquids 7 and 7′ emerge separately through the two apertures 4 and impregnate the felt or sponge 6, and can be applied by contact thereof with a surface. When the felt or sponge 6 is impregnated or on application to a surface, the two components 7 and 7′ are mixed and/or they may react with one another. To wipe off the liquid 7 from a substrate surface, the means 1 in this embodiment has a porous carrier material 5 on the base 11, i.e., on the side opposite the aperture 4. This embodiment represents in particular a single-use pack for the application and wiping off of a liquid. It is especially suitable for small quantities. This pack is suitable in particular for the pretreatment of a vehicle sheet, more particularly of an automobile glazing sheet.

FIG. 6B shows a further embodiment of the means 1 of the invention as already described in FIG. 6A. In contradistinction to the means 1 in FIG. 6A, the means 1 of the invention shown in FIG. 6B has a container 2 with two chambers 15 which are separated from one another by a partitioning wall 14, which is arranged transversely in the container 2. By bending of the outside walls 9 or by striking on the outside walls 9 of the container 2, made of plastic or cardboard, the partitioning wall 14 may rupture or tear or burst, and so the two components 7 and 7′ are able to mix and/or react with one another. Mixing may be assisted by shaking. The container may further comprise a mixing element, such as one or more balls 13, for example, as a mixing aid, to allow effective mixing of the at least two components 7 and 7′. The ball 13 may be provided, if required, with points or edges in order to facilitate tearing or destruction of the partitioning wall 14. The thickness and nature of the partitioning wall 14 and also the amount and surface design of the balls used should be chosen such that the partitioning wall 14 can be destroyed by simple shaking of the pack, but not unintentionally, as in the case even of small vibrations of the kind which occur during transportation. The reaction mixture formed from the first and second components 7 and 7′ emerges through the at least one aperture 4 and impregnates the felt or sponge 6, and can be applied by means of contact thereof with a surface.

It will be appreciated that the invention is not confined to the exemplary embodiments described and shown. It will be understood that the aforementioned features of the invention can be used not only in the combination specifically indicated but also in other modifications, combinations, and amendments or on their own, without departing from the scope of the invention.

### EXAMPLES

The substrate surface used was the air side of a float glass from the company Rocholl, Schönbrunn, Germany. To pretreat the float glass surface, a means of the invention and a conventional method were employed, and the adhesion of the adhesive to the surface pretreated with the means of the invention was compared with the adhesion of the adhesive to the surface pretreated by a conventional method. The adhesion promoter composition used for application to the float glass surface was Sika® Activator (available commercially from Sika Schweiz AG). Both for application and for wiping off, in both cases, felts of 100% wool were used from Filzfabrik Fulda GmbH, Germany. One test was carried out with hard felt, with a felt density of 0.36 g/cm³, hardness according to DIN 61200: F2, pH 6-8; in other words, a hard felt was used both for application and for wiping off. A second test was carried out with a soft felt, having a felt density of 0.18 g/cm³, hardness according to DIN 61200: M1, pH 6-8; in other words, a soft felt was used both for application and for wiping off. After the float glass surface had been pretreated, in other words following the application and, where appropriate, wiping off of the adhesion promoter composition, an adhesive was applied to the surface of the glass. In each case, triangular beads of the one-component, moisture-curing polyurethane adhesive SIKATACK®—MOVE GOES COOL (available commercially from Sika Schweiz AG) were applied by means of an extrusion cartridge and nozzle. The triangular beads were pressed using polyethylene films (available commercially from Prodinger Verpackung AG, Switzerland).

The adhesive was tested after a cured time of 7 days' controlled-atmosphere chamber storage (CL) (23° C., 50% relative humidity) and also after subsequent water storage for 7 days at 25° C. (WL) and also a subsequent heat/humidity storage (HL) of 7 days at 70° C. and 100% relative humidity.

The adhesion of the adhesive was tested by means of the ‘bead test’. In this test, the bead is incised at the end just above the adhesion face. The incised end of the bead is held with round-end tweezers and pulled from the substrate. This is done by carefully rolling up the bead on the tip of the tweezers, and placing a cut vertical to the bead pulling direction down to the bare substrate. The rate of bead removal is selected so that a cut has to be made around every 3 seconds. The test length must amount to at least 8 cm. An assessment is made of the adhesive which remains on the substrate after the bead has been pulled off (cohesive failure). The adhesion properties are evaluated by estimation of the cohesive failure of the adhesion face:

1=>95% cohesive failure

2=75-95% cohesive failure

3=25-75% cohesive failure

4=<25% cohesive failure

5=0% cohesive failure (purely adhesive failure)

Test results with cohesive failures of less than 75% are typically deemed inadequate.

The adhesion results from table 1 show that effective adhesion of the adhesive to the glass surface is obtained when the adhesion promoter composition is wiped off again following application. The results in the case of the test where the means of the invention was used to apply, and wipe off again, the Sika® Activator adhesion promoter composition are equally good as when the adhesion promoter composition was applied by a conventional method and wiped off using a separate felt.

TABLE 1
Adhesion results, bead test with evaluation after
different forms of storage (CL/WL/HL).

| | Soft felt | | | Hard felt | | |
|---|---|---|---|---|---|---|
| | CL | WL | HL | CL | WL | HL |
| Application only | 3 | 5 | 5 | 2 | 4 | 3 |
| Application and wiping off, reference | 1 | 1 | 1 | 1 | 1 | 1 |
| Application and wiping off with means | 1 | 1 | 1 | 1 | 1 | 1 |
| of the invention | | | | | | |

### LIST OF REFERENCE SYMBOLS

1 means for applying and wiping off a liquid
2 container
3 filling chamber
4 aperture
5 porous carrier material
6 application means
7 liquid, first component
7′ liquid, second component
8 minicontainer
9 outer side
10 lid
11 base
12 side wall/casing
13 mixing ball
14 partitioning wall
15 chamber

1. A means for applying and wiping off a liquid, comprising a container having a filling chamber and at least one aperture for applying the liquid, wherein the means, on at least one outer side of the container that does not have the at least one aperture, has at least one porous carrier material for wiping off the liquid.

2. The means of claim 1, wherein the filling chamber contains at least one liquid, comprising an adhesion promoter composition.

3. The means of claim 2, wherein the adhesion promoter composition comprises at least one adhesion promoter substance selected from the group consisting of organosilicon compound, organotitanium compound, and organozirconium compound.

4. The means of claim 2, wherein the porous carrier material is disposed on the outer side of the container that is opposite the aperture.

5. The means of claim 1, wherein the container is of hollow-cylindrical shape.

6. The means of claim 1, wherein the container has an application means on the outer side bearing the aperture.

7. The means of claim 1, wherein the porous carrier material is a sponge or a fiber material.

8. The means of claim 1, wherein the application means is a sponge or a fiber material.

9. The means of claim 1, wherein the at least one liquid is present directly in the filling chamber.

10. The means of claim 1, wherein the filling chamber comprises at least one minicontainer containing at least one liquid.

11. The means of claim 10, wherein the minicontainer is fabricated from a material which can be destroyed by the application of pressure.

12. The means of claim 1, wherein the container is composed of plastic.

13. (canceled)

14. The method of claim 17, wherein the liquid is an adhesion promoter composition.

15. The method of claim 14, wherein the adhesion promoter composition comprises at least one adhesion promoter substance selected from the group consisting of organosilicon compound, organotitanium compound, and organozirconium compound.

16. The method of claim 14, wherein the adhesion promoter composition comprises at least one solvent.

17. A method of applying and wiping off a liquid on at least one substrate surface S1 using the means of claim 1, comprising the steps of
(a) applying the liquid, with the side bearing the aperture, to a substrate surface S1, and
(b) wiping off the liquid with the side bearing the porous carrier material.

18. A method of adhesively bonding substrates S1 and S2, comprising the steps of
(a) applying and wiping off an adhesion promoter composition in accordance with a method of claim 17 to a substrate S1 and/or a substrate S2;
(b) applying an adhesive to a substrate S1 and/or a substrate S2;
(c) contacting the substrates S1 and S2 via the adhesive applied; and
(d) curing the adhesive,
the substrates S1 and S2 being alike or different from one another.

19. A method of sealing, comprising the steps of
(a) applying and wiping off an adhesion promoter composition in accordance with a method of claim 17 to a substrate S1 and/or a substrate S2;
(b) applying a sealant between a substrate S1 and a substrate S2; and
(c) curing the sealant,
the substrates S1 and S2 being alike or different from one another.

20. The method of claim 18, wherein at least one of the substrates, S1 or S2, is selected from the group consisting of glass, glass ceramic, concrete, mortar, brick, tile, plaster, a natural stone, a metal or an alloy, a wood, a plastic, a powder coating, and a paint or a finish.

21. An adhesively bonded article produced by means of a method of adhesive bonding of claim 18.

22. A sealed article produced by means of a method of sealing of claim 19.

23. An adhesively bonded or sealed article of claim 21, wherein the article is a built structure, an industrial product or a means of transport.
